(19) United States
(12) Patent Application Publication
(10) Pub. No.: US 2010/0254390 A1
(43) Pub. Date: Oct. 7, 2010

(54) METHOD OF AND APPARATUS FOR STATISTICAL PACKET MULTIPLEXING

(76) Inventors: Zigmantas Leonas Budrikis, Western Australia (AU); Antonio Cantoni, Western Australia (AU); John Leslie Hullett, Western Australia (AU)

Correspondence Address: OCCHIUTI ROHLICEK & TSAO, LLP, 10 FAWCETT STREET, CAMBRIDGE, MA, 02138, US

(21) Appl. No.: 12/676,036

(22) PCT Filed: Sep. 3, 2009
(86) PCT No.: PCT/AU2009/001148

§ 371 Date: Mar. 2, 2010

(30) Foreign Application Priority Data
Sep. 3, 2008 (AU) 2008904582

(51) Int. Cl. H04L 12/56

(52) U.S. Cl. 370/395.1; 370/412

(57) ABSTRACT

A method of managing transfer of packets in a packet digital communications network wherein at least some of the packets comprise a plurality of segments is disclosed. The method comprises providing a buffer (104) for storing segments arriving for transmission on a virtual channel, always admitting (150) a segment of a packet on a virtual channel for storage in the buffer (104) when a previous segment of the packet on said virtual channel has been admitted in the buffer (104), rejecting (149) a segment of a packet on a virtual channel for storage in the buffer when any previous segment of the packet on said virtual channel has been rejected for storage, and applying an admission criterion to each first segment of a packet on a virtual channel. The admission criterion is dependent on the level of fill of the buffer at the time of arrival of said first segment on the virtual channel and on a preference classification assigned to the virtual channel, and the admission criterion is used to determine whether to admit said first segment into the buffer. A corresponding communications system and network switch (90) are also disclosed.

### FIELD OF THE INVENTION

The present invention relates to transfer of packets over switched networks, and particularly to Internet packet transfers over broadband networks.

### BACKGROUND OF THE INVENTION

The Internet has evolved as a worldwide computer communications network, wherein digital data packets can be sent between any two computers associated with the network. In the wide area, nationally and beyond, the Internet has become a de facto public networking services provider, supporting a range of applications in private, government, commercial and other communications. Applications for the Internet encompass data exchange and dissemination such as electronic mail, computer file transfers, World Wide Web (WWW) and broadcast downloads, as well as real time signal transfers such as Voice over Internet (VoIP), video conferencing, live outside broadcasting from remote locations to studio, and so on.

It is generally desired that packets be transferred with utmost speed and reliability. However, how fast and reliable packet transfers really need to be depends on the particular requirements of the application, and on the demands of the service user, such as the price per service that the user would be prepared to pay.

In one arrangement, transfer of Internet packets over a wide area is provided by a common carrier in a manner according to FIG. 4 which shows Internet routers 40a . . . 40g with attached computers 42, 44, 46 interconnected over a core network 900. The core network 900 is a common carrier which is purpose adapted to facilitate transfer of Internet packets.

In this example, packet transfers are over virtual connections. For instance, router 40g could have a virtual connection to router 40b by a virtual channel that starts on in-going link 85, is cross-connected by switch 64 to a virtual channel on link 83, by switch 62 to a virtual channel on link 82, and finally is cross-connected by switch 61 to a virtual channel on outgoing link 81. If there was choice of transfer services of different speed and reliability, the differences in characteristics would be inherent in the particular virtual connections that could be chosen for the transfer.

To achieve the lowest possible average packet transfer delay, the network should be broadband and up to all of the bandwidth on network links should be available to the transfer of an individual packet. To get the maximum possible bandwidth, packets should share statistically in the capacity of the links; multiple packets needing to traverse a particular link should be time multiplexed as whole packets if they are not segmented for transfer, or as whole segments if the packets are segmented.

Packet segmentation is used to reduce the average transfer delay of a packet, and particularly the variable part in the delay. Dividing a long packet into short segments and sending the segments as independent sub-packets for reassembly at the destination reduces the delay by a substantial factor. The average delay is reduced because at switching nodes only a short segment needs to arrive and be stored at a time whereupon it can be forwarded immediately, while otherwise the whole packet would need to arrive before any forwarding. If a packet comprises n segments, the saving in delay at each visited node is a [(n−1)/n] fraction of its transmission time on an incoming link to the node. There is further delay due to waiting in queue that may occur at each switch output. This delay depends strongly on traffic intensity into an output link from the node, on the lengths and number of all competing packets and on the maximum length to which queues are permitted to grow. The number of packets is larger in segmented packet transfer and this is countered with a large margin by the combined force of the remaining factors, giving a much larger queue waiting and hence variable packet delay in non-segmented, as compared to segmented, transfer. To obtain maximum reduction in the variable delay, all packets need to be segmented uniformly and transmitted segments need to be multiplexed independently of the packets from which they came.

While only average delays are of interest in ordinary data communication, in real time communications the delays of individual packets, and hence the average and peak delays of the ensemble, are of critical concern. With ordinary communications minimum but not bounded packet delay is required. With real time communications the requirement is for minimum and bounded delay. Given that the Internet is expected to become capable of supporting adequately all communications, including real time communications, the core network 900 in FIG. 4 must function in a manner that would permit it.

A first requirement is that the core network be broadband, i.e. have link speeds of the order of 1 Gbps and higher. A second requirement is that waiting in queues anywhere in the network should never be more than about a millisecond. A third, and in the present circumstances most arduous requirement, is that packet losses due to discard should be capped, at least in cases of real time communications, to at most one packet per thousand.

Provision of broadband per se presents few problems. Limiting the time spent waiting in queues requires putting a bound on queue length, the boundary scaled in relation to link rate. Controlling packet discards, so that the number of lost packets in a designated category is capped, is not easy when no control of traffic rates and no reservations of resources exist.

With packets transmitted on virtual channels over links without any rate limitations other than that the total aggregated rate on a link cannot exceed the link capacity, and with any number of incoming links, for instance into switch 62 in FIG. 4, having virtual channels whose packets are switched to an outgoing link, for instance outgoing link 82, the total traffic ρ for the outgoing link 82 can over any time interval be (0≦ρ≦m−1), where m is the number of input ports and the capacity of a link is unity. Given that the capacity of the output buffer of the switch is finite, there is a finite probability ρ that packets are lost, no matter what the value of ρ, and packets are lost with probability (1≧p>ρ−1) whenever 0≦ρ<2. Packets may also be discarded intentionally at any level of buffer fill so as to achieve desired outcomes.

Packet loss ratio values are shown at a number of traffic intensity (ρ) and maximum number (N) of buffered packets in Table I.

TABLE I
PACKET LOSS RATIOS (PLR) AT DIFFERENT BUFFER LIMITS
IN NUMBER OF PACKETS (N) AND AGGREGATED TRAFFIC
INTENSITIES (ρ)

| | N | | | | |
|---|---|---|---|---|---|
| ρ | 2 | 6 | 10 | 14 | ∞ |
| 0.1 | 0.0090 | 9 × 10⁻⁷ | 9.0 × 10⁻¹¹ | 9.0 × 10⁻¹⁵ | 0 |
| 0.3 | 0.0647 | 0.0005 | 4.1 × 10⁻⁶ | 3.4 × 10⁻⁸ | 0 |
| 0.6 | 0.1837 | 0.0192 | 0.0024 | 0.0003 | 0 |
| 1.0 | 0.3333 | 0.1429 | 0.0909 | 0.0667 | 0 |
| 1.3 | 0.4235 | 0.2745 | 0.2444 | 0.2354 | 0.2308 |
| 1.6 | 0.4961 | 0.3895 | 0.3771 | 0.3753 | 0.3750 |
| 2.0 | 0.5715 | 0.5040 | 0.5003 | 0.5000 | 0.5000 |
| 3.0 | 0.6923 | 0.6670 | 0.6667 | 0.6667 | 0.6667 |

An illustration of how lost packets in real time communications might be kept to one per thousand or less can be constructed by inspection of the numbers in Table I. The limit on queued packets could reasonably set at 14. If the packet intensity in real time packets was 0.3, and only real time packets were admitted into the buffer while the number of queued packets is nine or more, but not exceeding 13 (When the number is 14, no further packets are admitted), then the packet loss ratio for real time packets would be less than 0.0005, or less than 5 packets in 10 thousand.

The maximum time spent waiting in queue is directly proportional to the product of the maximum number of packets allowed to queue and the maximum size of queued packets; it is inversely proportional to the output link rate. If the maximum packet size allowed is 64 Kbytes and the maximum number of packets admitted into the queue is 14, then the queue waiting time would be limited to one millisecond only if the link rate was 7.3 Gbps or higher. If for any reason the network has to have links of lesser rate, e.g. 2.5 Gbps or smaller, then there needs to be a reduction in permitted packet size, or segmentation should be used, or both reduced maximum packet size and segmentation are used. Segmentation should be mandatory if the link rate is only 1 Gbps or less.

All early and still used wide area broadband Internet networks employ Asynchronous Transfer Mode (ATM) in which segmentation is inherent. Any packets longer than 48 bytes are cut into 48 byte segments that are carried in 53 byte segments. These ATM segments then become the packets that are switched, buffered, and multiplexed. The ATM technology was developed 1988-2000 as part of standardization in the International Telecommunications Union (ITU) and ATM Forum towards the Broadband Integrated Services Digital Network (BISDN). With the Internet taking on provision of many, if not all, of the services that the BISDN was meant to provide, and some more, there would seem to be a path of least effort for it to take some of the ATM technology, at least for the lower end of broadband.

In the standardization, several ATM layer transfer capabilities (ATC) were produced, each intended to satisfy the requirements of a particular class of services in the BISDN. However, no ATC was produced that would support statistically multiplexed transfer of connectionless packets.

The adopted ATM layer transfer capabilities generally have specified bit rates and put limits on the rate at which information may be presented for transfer, but in return they guarantee the transfer and its quality. Unspecified bit rate (UBR) imposes no restrictions on rate, but also makes no promise of service other than that the service is at lowest priority and that packet transfer occurs whenever necessary, but only as much of a packet as is possible. It is often termed ‘best effort service’.

Before commencement of any real time communications over the Internet, bit or segment rate specifications had no basis in Internet communications, since generally there was no requirement that every sent packet should reach a destination. Consequently, UBR appeared to be a reasonable choice.

However, packet losses proved to be much worse than had been expected. Since complete packets have to reach their destination to be at all received, and with UBR in any instance of overload individual segments are discarded, the number of packets lost during a buffer overflow, can approach the number of discarded segments. Consequently, the packet loss ratio is M×(segment loss ratio), where M approaches the average number of 48-byte segments per IP packet. With any loss multiplier greater than one there is danger of congestion. With the size of loss multiplier that transpired in UBR transfer of Internet packets, network congestions became overwhelming.

Understandably, the problem of congestion caused by Internet traffic in ATM networks was soon addressed both by the ATM Forum and ITU. At the Forum's urging, most hope and effort were invested in defining available bit rate (ABR) to replace UBR. With ABR, signals from any overburdened switch outputs are sent to all concerned traffic sources, thereby advising on suitable input segment rates so that switch buffer fills are kept below overflow level, while still giving reasonably high network utilization and adequate speeds. The scheme proved complex, yet uncertain in effectiveness. The ABR scheme has now been in existence for over ten years, but has not been widely adopted.

However, even before ABR was complete, a much simpler solution was identified. This solution uses no feedback control, only discard of data at points of overload. With this scheme, the discard is only of whole packets and never isolated segments. It is often termed early packet discard (EPD). With early packet discard, there is no loss multiplication and hence no congestion.

It might fairly be said that early packet discard has turned UBR into a powerful transfer capability that is adequate for connectionless packets that require no bound on packet loss and hence also on message delay. Accordingly, it has made ABR superfluous.

### SUMMARY OF THE INVENTION

The broad objective of the present invention is to provide a method of and apparatus for managing the statistical multiplexing of heterogeneous message segments in a digital communications network.

In accordance with a first aspect of the present invention, there is provided a method of managing transfer of packets in a digital communications network, at least some of said packets comprising a plurality of segments, said method comprising:
providing a buffer for storing segments arriving for transmission on a virtual channel;
always admitting a segment of a packet on a virtual channel for storage in the buffer when a previous segment of the packet on said virtual channel has been admitted in the buffer;
rejecting a segment of a packet on a virtual channel for storage in the buffer when a previous segment of the packet on said virtual channel has been rejected for storage; and
applying an admission criterion to each first segment of a packet on a virtual channel, said admission criterion being dependent on the level of fill of the buffer at the time of arrival of said first segment on the virtual channel and on a preference classification assigned to the virtual channel, and said admission criterion being used to determine whether to admit said first segment into the buffer.

In this way, the present method provides a scheme that makes it possible to provide different service classes in connectionless packet transfer, while nonetheless maintaining overall statistical sharing of network resources.

In one embodiment, each preference classification has at least one associated buffer threshold fill level, said admission criterion for a packet on a virtual channel being dependent on a comparison of the actual buffer fill level at the time of arrival of the segment with the buffer threshold fill level associated with the preference classification assigned to the virtual channel. The buffer threshold fill levels may be such that a relatively high preference classification has an associated relatively high buffer threshold fill level, and a relatively low preference classification has an associated relatively low buffer threshold fill level.

In one embodiment, at least some of the packets comprise one segment.

In one embodiment, the communications network is an ATM network.

In one embodiment, the buffer is an output buffer of a network switch.

In one embodiment, the method comprises assigning a preference classification to a virtual channel, each virtual channel having an associated virtual channel identifier, the step of assigning a preference classification comprising dividing virtual channel identifiers into at least two disjoint subsets, and assigning to each said subset a particular preference classification ranging from most preferred to least preferred.

The method may comprise communicating assigned preference classifications to all network switches in the network.

In one embodiment, the method comprises storing at each network switch a status record for each virtual channel, said status record being indicative of whether a segment of a packet on a virtual channel arriving after a first segment in the packet should be discarded.

The status record may comprise data indicative of a serial number of the subsequent segment to arrive on a virtual channel, and a segment discard flag D indicative of whether the subsequent segment should be discarded.

In one arrangement, the status record also comprises information associated with real time communications. Such information may comprise a real time provisional flag, a real time confirmed flag, a time stamp T and a packet stream period DT.

In one arrangement, the method comprises providing a random access memory for storing status records for all virtual channels on which segments may arrive for transmission.

In one embodiment, the method comprises updating at a network switch the status record associated with a segment on arrival of the segment at the network switch.

In one embodiment, the method comprises retrieving a status record associated with a segment on arrival of the segment at a network switch and using the discard flag in the status record to determine whether to store the segment in the buffer or discard the segment.

In one embodiment, a segment comprises a header having a payload type identifier (PTI) indicative of whether the segment is a user data segment, and the method comprises checking the PTI on arrival of a segment, storing the segment in the buffer if the segment is not a user data segment, and retrieving the status record associated with the segment if the segment is a user data segment.

In one embodiment, the method comprises using the PTI in a received segment header to determine whether the segment corresponds to end of packet, amending the serial number in the status record associated with the segment to indicate that the next segment is the first segment in a subsequent packet, and amending the discard flag to indicate that the subsequent segment has not yet been marked for discard or storage in the buffer.

In one embodiment, the method comprises incrementing the serial number in the status record if the PTI in a received segment header does not indicate end of packet.

In one embodiment, in communications networks having a maximum packet length, the method may be arranged to check whether the serial number is indicative of a packet exceeding the maximum packet length, and to reset the status record if a packet exceeding the maximum packet length is detected.

In one embodiment, the method comprises detecting at a network switch arrival of a first segment in a packet, and when a first segment in a packet is detected:
determining the preference class of the virtual channel associated with the segment;
comparing the current buffer fill level with a threshold fill level associated with the preference class and
   if the current buffer fill level is less than the associated threshold fill level, set the discard flag so as to indicate that the segment is not to be discarded; and
   if the current buffer fill level is equal to or more than the associated threshold fill level, set the discard flag so as to indicate that the segment is to be discarded.

In one embodiment, the method comprises:
if a virtual channel is determined to correspond to the highest preference class:
determining whether a virtual channel is associated with real time communication; and
if the virtual channel is associated with real time communication, assigning real time status to the virtual channel.

In one embodiment, the step of determining whether a virtual channel is associated with real time communication comprises monitoring an arrival pattern of packets on the virtual channel.

The step of determining whether a virtual channel is associated with real time communication may comprise monitoring the regularity of arrival of packets on the virtual channel.

In one arrangement, the step of determining whether a virtual channel is associated with real time communication comprises:
determining the time of arrival of a first segment in a packet;
comparing the current buffer fill level with a real time threshold buffer fill level;
if the current buffer fill level is less than the real time threshold buffer fill level, mark a provisional real time flag in the status record to indicate a possible real time communication;
if the provisional real time flag in the status record indicates a possible real time communication, calculate a time interval between arrival of a first segment in a current packet and arrival of a first segment in an immediately previous packet;
comparing the calculated time interval with minimum and maximum threshold time interval values;
if the calculated time interval is above the minimum time interval threshold and below the maximum time interval threshold, mark a confirmed real time flag in the status record to indicate a confirmed real time communication and thereby real time status for the virtual channel; and
storing the time interval as a reference time interval.

The reference time interval may be stored in the status record.

In one embodiment, the step of determining whether a virtual channel is associated with real time communication further comprises:
if the confirmed real time flag in the status record indicates a confirmed real time communication, calculating a time interval between arrival of a first segment in a current packet and arrival of a first segment in an immediately previous packet as each packet arrives on a virtual channel;
comparing the calculated time interval with the reference time interval;
if the calculated time interval is within a defined tolerance of the reference time interval, maintain the confirmed real time flag in the status record and thereby maintain real time status for the virtual channel; and
if the calculated time interval is not within the defined tolerance of the reference time interval, mark the provisional real time flag and the confirmed real time flag in the status record to indicate that the communication is not a real time communication, thereby revoking real time status for the virtual channel.

In one embodiment, the step of determining whether a virtual channel is associated with real time communication further comprises:
if the confirmed real time flag in the status record indicates a confirmed real time communication and thereby is assigned real time status, calculating a time interval between arrival of a first segment in a current packet and arrival of a first segment in an immediately previous packet as each packet arrives on a virtual channel;
comparing the calculated time interval with twice the reference time interval;
if the calculated time interval is within a defined tolerance of twice the reference time interval, maintaining the confirmed real time flag in the status record and thereby confirming real time status for the virtual channel; and
if the calculated constancy time interval is not within the defined tolerance of twice the reference time interval, mark the provisional real time flag and the confirmed real time flag in the status record to indicate that the communication is not a real time communication, thereby revoking real time status for the virtual channel.

According to a second aspect of the present invention, there is provided a network switch for managing transfer of packets in a digital communications network, at least some of said packets comprising a plurality of segments, said switch comprising:
a buffer for storing segments arriving for transmission on a virtual channel;
a packet and segment admission controller arranged to determine whether to admit a received segment into the buffer or to discard the segment;
the packet and segment admission controller being arranged to:
   always admit a segment of a packet on a virtual channel for storage in the buffer when a previous segment of the packet on said virtual channel has been admitted in the buffer;
   reject a segment of a packet on a virtual channel for storage in the buffer when a previous segment of the packet on said virtual channel has been rejected for storage; and
   apply an admission criterion to each first segment of a packet on a virtual channel, said admission criterion being dependent on the level of fill of the buffer at the time of arrival of said first segment on the virtual channel and on a preference classification assigned to the virtual channel, and said admission criterion being used to determine whether to admit said first segment into the buffer.

According to a third aspect of the present invention, there is provided a semiconductor chip comprising a network switch according to the second aspect of the present invention.

According to a fourth aspect of the present invention, there is provided a communications network comprising a plurality of network switches according to the first aspect of the present invention, said switches being interconnected in a mesh network.

### BRIEF DESCRIPTION OF THE DRAWINGS

The present invention will now be described, by way of example only, with reference to the accompanying drawings, in which:

FIG. 1 shows a structure of an ATM segment;

FIG. 2 shows a header of the ATM segment shown in FIG. 1 at the Network-Node Interface;

FIG. 3 shows a layered ATM architecture;

FIG. 4 shows an existing network schema of IP over ATM to which the invention can be advantageously deployed;

FIG. 5 is a schematic representation of an ATM switch in accordance with the present invention;

FIG. 6 is a representation of a logical implementation of a buffer assembly of the switch shown in FIG. 5;

FIG. 7 shows a block schematic diagram of a VC status records memory and exemplary record format for use in the buffer assembly shown in FIG. 6;

FIG. 8 is a flow diagram illustrating a method of statistical packet multiplexing according to an embodiment of the present invention;

FIG. 9A is a flow diagram illustrating operation of a segment admission controller part of the buffer assembly shown in FIG. 6;

FIG. 9B is a flow diagram illustrating operation of a packet admission controller part of the buffer assembly shown in FIG. 6;

FIG. 10 is a flow diagram illustrating operation of a packet and segment admission controller of the buffer assembly shown in FIG. 6 on receiving a signal from a segment read controller of the buffer assembly shown in FIG. 6;

FIG. 11 is a flow diagram illustrating operation of a segment read controller of the buffer assembly shown in FIG. 6 on receiving a signal from the packet and segment admission controller of the buffer assembly shown in FIG. 6; and

FIG. 12 is a flow diagram illustrating operation of a segment read controller of the buffer assembly shown in FIG. 6 on reading a segment from the output buffer of the buffer assembly shown in FIG. 6.

### DETAILED DESCRIPTION OF AN EMBODIMENT OF THE INVENTION

In a preferred embodiment, an objective of the method and system is to manage statistical multiplexing of heterogeneous message segments at switching nodes of a digital communications network, where said message segments carry identifying labels and are relayed and relabelled at said switches in accordance with stored switching tables. If segmented, said messages are identified by their segments in that at any point in the network all segments of a message carry exclusively the same identifier in their label, and consecutive segments of the message follow one another in proper sequence, with the label of the last segment having an end-of-message indication.

The statistical packet multiplexing arrangement associated with the present invention may be termed deferred packet discard (DPD) and enhances the service transfer capabilities of connectionless packets per se and thus of the Internet. Just as EPD, so also DPD can be applied to ATM networking. However, it will be understood that the invention is applicable to other types of network communications, including networks which comprise at least some whole (un-segmented) packets.

Deferred packet discard builds on principles that underlie early packet discard and connection admission control. By shifting the focus to buffer admission, EPD is seen as an admission decision that is made locally at a switch, based on a prediction of adequate resource to transfer a complete packet irrespective of 1) the rate with which parts of the packet will arrive, so long as that rate is not higher than any rate possible on input links, and 2) of the length of the packet so long as it does not exceed the maximum length permitted. The basis for the decision to admit is that, given the newly admitted packet, the probability that the buffer could overflow should remain negligible.

It may be recognized that more criteria than prevention of buffer overflow could advantageously underlie the packet admission decision, such as differentiated quality of service classes in UBR transfer of packets, whereby the quality of service is expressed by a probability metric on packet discard.

The present embodiment provides an arrangement whereby connectionless packets can be transferred over a switched packet network without resource reservation and with the network utilization close to one hundred percent. In all cases, including where segmented packets are transferred, losses are always of whole packets.

The present method provides for differential quality of service delivery, wherein quality of service is characterized by packet loss probability. In the present embodiment, this is achieved by creation of a number of quality classes. With this embodiment, a packet of the lowest class (designated numerically by a relatively high number) is discarded whenever the buffer fill is above a relatively low threshold. A packet associated with the highest class, class 1, is discarded only when the buffer fill level is above the highest threshold.

Assuming that packets are label switched, the identification of class may be incorporated in the switching label. The same class would apply to the entire length of a virtual connection. Assuming that labels are administered by the network, transfer classifications may be governed and dispensed centrally by the network.

The method also provides for additional, locally bestowed privilege to selected virtual connections in class 1. Extra high preference (extra-high discard threshold) is granted to a class 1 virtual channel proceeding into a particular outgoing link only when the general level of traffic into the link is low enough and the observed pattern of packet arrivals on the channel is such as to suggest that the communication on it is real time. Once given, the high privilege level is maintained irrespective of the subsequent level of traffic but only so long as the pattern of packet arrivals remains unchanged. Additional privileged communications should have vanishingly small probabilities for lost packets even during times of severe general overload.

The invention includes methods of identifying packet arrivals that are deemed as being associated with real time communication. The arrival pattern taken as suggestive of real time is regular arrivals at fixed intervals, irrespective of regularity or variability in packet lengths. This is based on cognizance that in packet carried transfer of a time-continuous signal, a significant delay component is the packet accumulation time and its effect on the total signal delay is a minimum if accumulation intervals are uniform, i.e packets are dispatched at constant intervals.

A particular embodiment of the present invention will now be described with reference to Asynchronous Transfer Mode (ATM) type communications. However, the following example should not be taken as in any way restricting the generality of the invention.

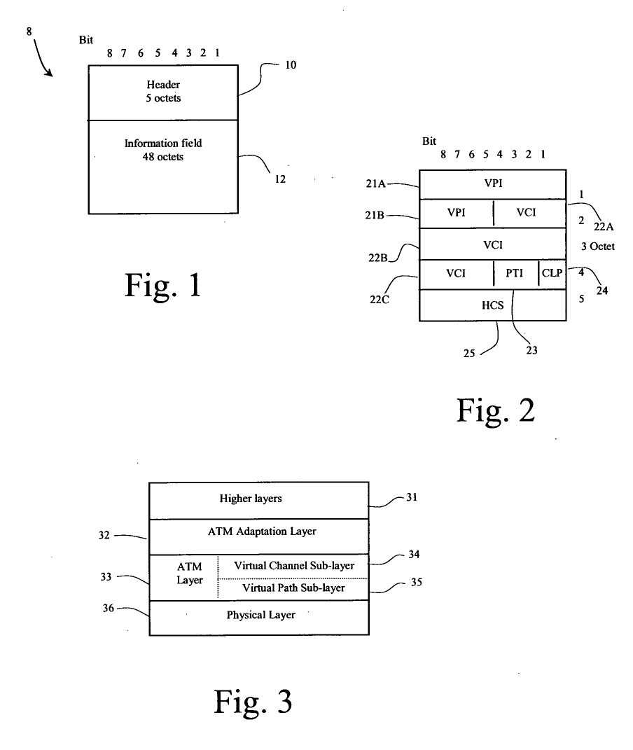

FIG. 1 shows a format outline of an ATM segment 8 consisting of a 48 octet information field 12 and a 5 octet header 10. FIG. 2 shows the standard format of the ATM header 10 at the network node interface (NNI). The header 10 consists of a 12 bit virtual path identifier (VPI) 21A & B, a 16 bit virtual channel identifier (VCI) 22A, B, & C, a three bit payload type identifier (PTI) 23, a segment loss priority (CLP) bit 24, and an eight bit header check sum (HCS) 25. The ATM header format at the user-to-network interface (UNI) differs from the format at the NNI in that the ATM header format has a VPI field of only 12 bits, and a four bit generic flow control (GFC) field in bit positions 5-8 of row 1.

A protocol reference model for ATM networking is shown in FIG. 3. The lowest or physical layer 36 is responsible for transmission and reception of ATM segments over one of a variety of transmission media and transmission systems. Immediately above the physical layer 36 is an ATM layer 33 consisting of a virtual path sub-layer 35 and a virtual channel sub-layer 34. At the ATM layer 33 segments from different virtual channels/virtual paths are multiplexed into a composite stream and passed to the physical layer 36 for transmission, while segments arriving from the physical layer are split into individual tributaries according to their VPI and VCI. An ATM Adaptation layer (AAL) 32 is responsible for segmentation of higher layer frames into ATM segment payloads for reassembly of received ATM segment payloads into higher layer frames.

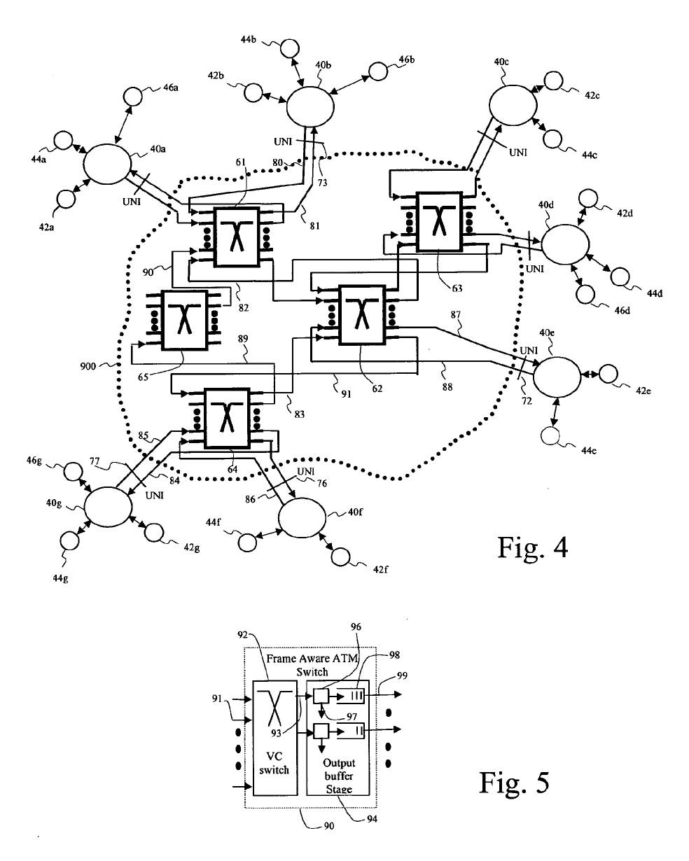

The most significant requirements in transfer of Internet packets are immediacy and speed. The transmission of a packet should commence as soon as it is presented and should be completed in the shortest possible time. It should pass through the network with the least hold-ups and experience most of its delay in physical propagation. FIG. 4 shows a schematic Internet network scenario to which the present embodiment of the invention may be applied.

In FIG. 4, local IP routers 40a . . . 40g serve attached hosts 42, 44, 46, and are interconnected over a wide area by a broadband core network 900, in this example an ATM network. The IP routers and switches 60, in this example ATM type routers and switches, are shown in separate administrative domains. The switches 61, 62 are nodes in a part-mesh connected network. IP routers have user status with regard to the ATM core network 900, are connected to the core at individual user-to-network interfaces (UNIs), and each router has links to one or more ATM core switches.

The transfer of a packet from one IP router to another across the core network 900 is on a suitable virtual connection. For instance, with reference to FIG. 4, a transfer from router 40g to router 40b may set out on a virtual channel across UNI 77 on link 85 to switch 64, where it is switched to link 83 and thereby to switch 62, then switched to link 90 and thereby to switch 61, and finally switched to link 81 by switch 61 to UNI 73 and router 40b.

To have the required immediacy, it is necessary that virtual connections already exist when packets arrive for transfer. This means that virtual connections between routers are set permanently. To have the required speed of transmission, the core network 900 has to be broadband with up to the entire bandwidth of a link being made available to individual packet transmissions. Therefore, the segment rate on virtual channels has to be unrestricted or virtual connections must be of unspecified bit rate (UBR). Since with UBR no bandwidth reservations are necessary or possible, permanent connections and maximum bandwidth are happily compatible. Any number of virtual connections can be set, including multiple connections between the same router pairs, without depleting much of network resources other than (locally available) labels and switching table spaces.

Within reason, any number of virtual connections can be set between a pair of routers, with given sequences of links using different VC identifiers. It is also possible to make connections over different network routes, as for instance between IP routers 40f and 40b in FIG. 4. Instead of the previously considered route over switches 64, 62, and 61, a route could be over switches 64, 65, and 61. Diversity of routes can help in traffic engineering, specifically in load balancing. In all cases diverse virtual connections would be set also in reverse directions. By ITU recommended practice, whenever a virtual connection is set in one direction, a return connection should be set with identical channel identifiers in the return direction.

Given that traffic on all set virtual channels in the core network 900 is of unspecified bit rate, and during packet transfers can be at up to network link rate, and given further that any number of channels on incoming links to a switch can be switched to any specified output link, it is inevitable that at times any of the output links on a switch can be overloaded. Therefore, all switch outputs in the core network 900 require output buffers that would help ride out the overload. Without control of buffer input, there is always risk of a buffer overflowing, no matter how large the capacity. Moreover, allowing buffers to overflow by spilling individual segments is undesirable since this leads to packet loss which approaches the number of segments lost. The present method offers packet admission control into switch output buffers that, besides preventing segment traffic spills, promises further quality related enhancements to transfer of IP packets over a communications network.

A network switch according to an embodiment of the present invention is shown in FIG. 5. In this example, the network switch is an ATM switch 90 with a buffer admission controller 96 associated with each output line. Such an ATM switch may be termed a Frame Aware ATM Switch.

The switch 90 comprises a VC switch 92 and an output buffer stage 94 including a controller 96 and a fill buffer 98. Segments arriving on any number of switch input lines 91 may, in accordance with switching table entries in the VC switch 92, be switched to any particular output line, such as output line 93. When the fill buffer 98 is over a minimum threshold fill level, consideration is given as to which packets may still be admitted into the fill buffer 98, and when a packet should be refused admission. The controller 96 is arranged such that when a first segment of a packet has been discarded, all of that packet's segments are shunted on arrival by the controller 96 to a discard line 97.

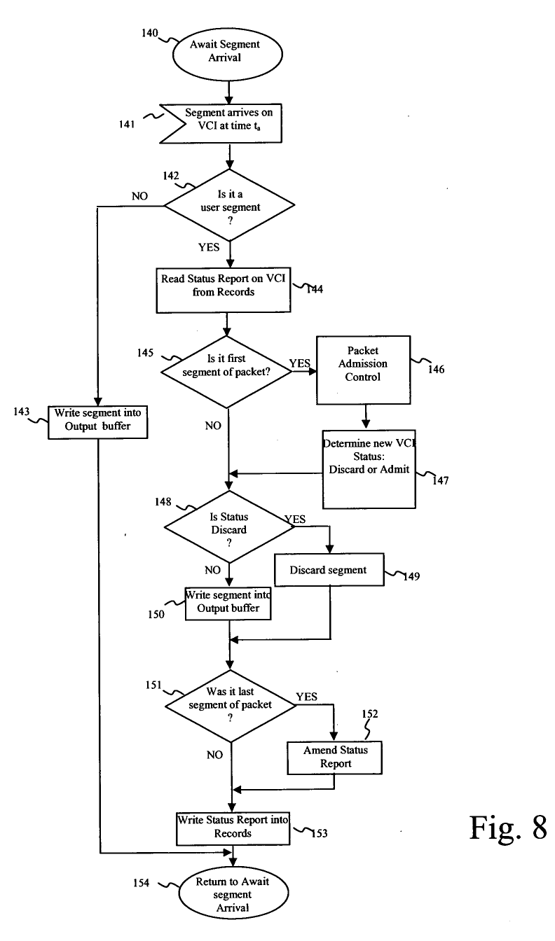

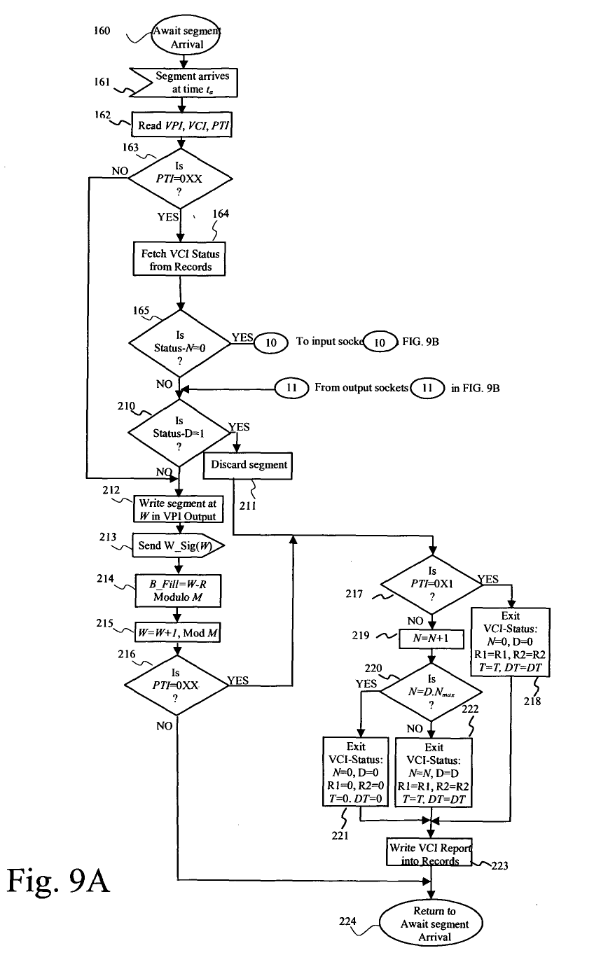

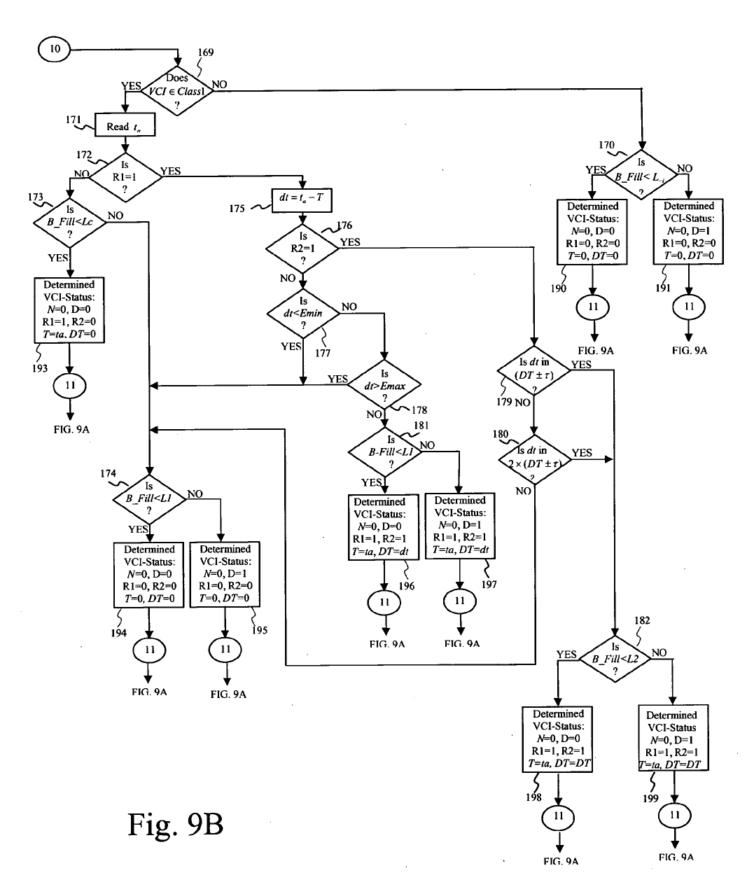

The task of the controller 96 is to ensure that a sufficient number of segments are shunted to the discard line 97, that only complete higher layer frames are shunted to the discard line 97, and further to ensure that the relative admission of higher layer frames is in accordance with set-down policy. In the present example, the policy is embodied in algorithms used by the controller 96. A sample set of algorithms which may be used by the controller 96 are represented in flow diagram form in FIGS. 8, 9A and 9B.

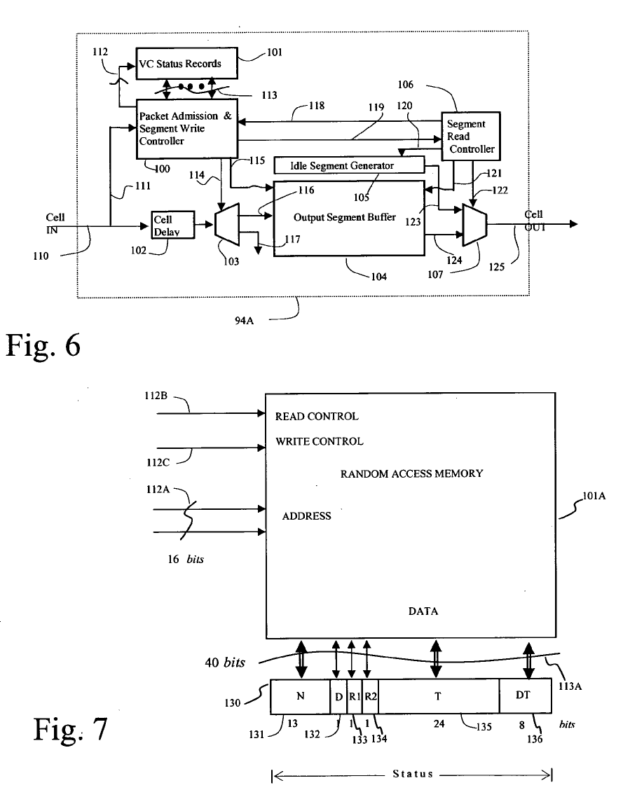

A portion 94A of the output buffer stage 94 associated with one access controlled buffer and one output line is shown in block schematic detail in FIG. 6.

The output buffer stage portion 94A comprises a packet admission & segment write controller 100, VC status records 101, a segment delay stage 102, a de-multiplexer 103, an output segment buffer 104, an idle segment generator 105, a segment read-out controller 106, and a multiplexer 107. However, it will be understood that other implementations are possible. For example, an alternative physical implementation might be a large scale integrated chip arranged so as to comprise distinct functional blocks different from those shown in FIG. 6. For instance, the segment write controller 100 and the segment read-out controller 106 could be one block, while the function of the idle segment generator 105 might be divided between the output segment buffer 104 and the segment read-out controller 106.

With reference to FIG. 6, segments enter the output buffer stage portion 94A serially on input line 110, and are stored temporarily in the segment delay stage 102. Some information from a segment, in this example derived from the segment header, is copied via line 111 to the packet admission & segment write controller 100. On the basis of the segment information and status information retrieved from VC Status Records 101 via lines 113 and from the segment read controller via line 118, the packet admission & segment write controller 100 determines whether the segment is to be written into the output segment buffer 104, by de-multiplexer 103 to line 116, or otherwise is to be discarded via discard line 117. The packet admission & segment write controller 100 gives an admission command indicative of whether the segment is to be admitted to the output segment buffer 104 or discarded to the de-multiplexer 103 on line 114. The packet admission & segment write controller 100 also provides a write address to the output segment buffer 104 on line 115. The write address is also given to the segment read controller 106 via a line 119. The segment read controller 106 initiates segment read-outs either from the output segment buffer 104 in response to a command on line 121 or, in the absence of segments in the output segment buffer, from the idle segment generator 105 in response to a command on line 120. The segments on line 124 and/or on line 123 are passed to the multiplexer 107, and then multiplexed to an outgoing link on line 125.

An advantageous implementation of the VCI status records block 101 is by a storage device, in this example a Random Access Memory 101A illustrated in FIG. 7. Status records 130 are shown as 40 bit words, stored in a 65,536-word random access memory, one for each VCI. With reference to FIG. 6, when entry via line 111 of segment information into the packet admission & segment write controller 100 is complete, the controller 100 fetches the relevant status record for the VCI by transmitting the VCI and read command over line 112 to the VC status records and receives the status record over lines 113. The controller 100 writes an updated VC Status Record 130 into Random Access Memory 101A, again presenting the address (the VCI) on lines 112A and write control command on line 112C.

With reference to FIG. 7, the register 130 shows a suggested format and content for a VC status record. In this example, the record has 48 bits and comprises 7 information fields.

A first field 131 is a 12-bit integer variable N that indicates the sequence number, starting with zero, of a segment within an associated packet.

The second, third, and fourth fields are logical variables, including a discard flag D 132, provisional preferred status flag R1 133, and a confirmed preferred status flag R2 134.

The fifth field is a 24-bit time stamp T 135 which indicates time by a number of defined time units, such as half-milliseconds. On receipt of a first segment of a packet (N=0), a non-zero T signifies the time of arrival of the first segment of the previous packet; for all other segments of the packet (N>0), a non-zero T indicates the time of arrival of the first segment of the current packet.

The sixth field 136 is an 8-bit Differential Time stamp DT. The DT is non-zero only for a VC that possesses confirmed preferred status; it indicates the time difference between the arrival of the first segment of a packet at which the present preferred status was confirmed, and the arrival of the first segment of an immediately preceding packet (when Preferred Status was provisionally granted).

Operation of the present method and system during use will now be described with reference to the flow diagrams shown in FIGS. 8, 9A and 9B.

Referring to FIG. 8, a segment arrives 141 at an output buffer stage portion 94A at time tₐ. If the segment is not a user segment (i.e. is an OAM segment), then it is written 143 (without any processing) into the output segment buffer 104. If the segment is a user segment, the relevant status record for the VCI given in the segment header is retrieved 144 from VC status records 101A. In light of the retrieved status record, a determination is made 145 as to whether the segment is the first segment of a packet. If it is the first segment, the packet admission control 146 is implemented wherein the new status for the VCI is determined and recorded 147. A determination is then made as to whether the status flag D of the segment indicates admission into the segment buffer 104 or discard. If D=0 (NO, do not Discard), the segment is written 150 into the output buffer 104. If D=1 (YES, Discard), the segment is discarded 149. A question is then asked 151 as to whether the segment is the last segment of the packet. If it is not, then the status record on the VCI is written into VC status records 101A. If the segment is the last segment in the packet, then an appropriate amendment of the Status record is made 152 before it is written into VC status records 101A.

FIGS. 9A and 9B show the flow diagram of FIG. 8 in greater detail. With reference to FIG. 9A, a segment arrives 161 and the time of its arrival tₐ is noted. At 162, the VPI, VCI, and PTI are read from the segment header. For simplicity, it is assumed that ATM switch outputs comprise single virtual paths and hence all segments arriving on line 110 in FIG. 6 would be with a particular VPI; reading the VPI would then be only for verification.

The VCI indicates the particular virtual channel from among the 2¹⁶=65,536 possible channels that the segment is on. The PTI indicates the type of payload of the segment and therefore whether the segment may be subject to control. If PTI=0XX, the indication is of a user data segment and therefore that the segment is subject to control. If PTI=1XX, the segment may be an operations & maintenance segment, or a resource management segment, or a reserved segment, and in all cases is not controlled. The determination as to whether the segment is subject to control is made at 163. If the segment is not subject to control, the segment is written 212 into the VPI output buffer, and after several further steps and a repetition of by-pass, the process returns to an idle state. If PTI=0XX, i.e. the segment is subject to control, the status record for the VCI is fetched 164 from VC status records 101A.

As indicated above, the VC status record 130 comprises multiple information fields (N, D, R1, R2, T, DT). After retrieving 164 the status record 130, a check is made as to whether N equals zero (which would indicate that the segment is the first of a new packet). If N=0, then the status of the VCI needs to be reviewed and, accordingly, the process illustrated by the flow diagram in FIG. 9B is implemented. If N≠0, that is the segment is not the first segment of a packet, then the current status record is valid, and the segment is dealt with in accordance with the remaining flowchart steps in FIG. 9A.

Referring to FIG. 9B, if the segment is the first segment of a new packet, a determination is made 169 as to whether the VCI is in a top preference class (Class 1), in this example by allocating subset Class 1 of {VCI}, e.g. Class 1={1XXXXXXXXXXXXXXX}. Any number of lower preference classes may be defined, each with a similarly allocated disjoint subset of {VCI}. The example implicit in the flow diagram shown in FIG. 9B has only one lower preference class with a VCI subset equal to the complement of Class 1.

It will be understood that higher preference classes have associated correspondingly higher buffer fill thresholds above which packets carried on VCIs of that class are discarded. While buffer fill is less than a relevant threshold, discard is deferred. Accordingly, packets carried on VCIs in Class 1 are given a higher buffer threshold than other classes and as such discard of these packets is deferred relative to packets associated with lower classes.

If the VCI is found at step 169 not to be in Class 1, a question is asked 170 as to whether the buffer fill B-Fill is less than a threshold Ls applicable for non Class 1 VCIs. If B-Fill is less than Ls, the packet is admitted and the status for the VCI is marked at step 190 with D=0 (Do not discard). If B-Fill equals or exceeds Ls, the packet is rejected and the status record for the VCI is initialized 191 with D=1 (Discard).

If the VCI is in Class 1, then the provisional preferred (real time) status parameter R1 is tested at step 172. If R1=0, then the buffer fill is tested at step 173 to determine whether real time status should be given. The test is whether buffer Fill is less than Lc, a network operator defined connection admission threshold above which no new grants of real time preferred status are made. Lc could be smaller than Ls. If B-Fill<Lc, the packet is admitted without further question, setting D=0 in the VCI-Status Record 193 as well as setting R1=1 and noting T=tₐ, both for use in the admission process when the next packet on that VC arrives.

If B-Fill≧Lc, real time status cannot be given and the VC remains in (ordinary) Class 1; the question is then whether the packet can be admitted to the segment buffer 104 on that basis. Step 174 indicates that a question is asked as to whether B-Fill is less than L1, which is the ordinary Class 1 threshold for packet admission. If B-Fill<L1, the packet is admitted (D=0) to the segment buffer 104, and other status parameters are also zeroed 194. If B-Fill≧L1, the packet is discarded (D=1), while other parameters are zeroed 195.

It will be understood that the threshold values are choices for the network operator. Thus Lc could be smaller, equal to, or larger than Ls, each possibility giving a different service character to the network.

If at step 172 R1=1, the elapsed time interval dt since the arrival of a previous packet is calculated:

dt=tₐ−T

A test is then carried out 176 as to whether the VCI has a confirmed real time status (i.e. whether R2=1). If real time status is only provisional (R2=0), a determination is made as to whether the real time status for the VCI can be progressed to confirmed, or whether the provisional real time status must be revoked, and thereby whether the packet should be admitted on the basis of L1, the ordinary Class 1 criterion. Confirmation of real time status depends on whether dt, the time interval since the arrival of the previous packet (when presumably the real time status was provisionally granted), falls within a defined window:

E min≦dt≦E max

i.e. dt is not less than Emin and is not larger than Emax. As at step 174 a question is then asked as to whether B-Fill is less than L1, which is the ordinary Class 1 threshold for packet admission. The outcome is again either accept (D=0 at step 196) or discard (D=1 at step 197). The remaining status parameters are no longer all zero; R1 and R2 are both set to one, T is set to to—the time of arrival of the present packet, and DT is set to the present measured dt. As future packets arrive on the given VCI and while its real time status is maintained, DT will stay unchanged.

Returning to decision diamond 176, if R2=1, i.e. the VCI has confirmed real time status, then a decision is made 179, 180 as to whether the real time status of the VCI is still valid. The status will be deemed valid if dt falls in the range of (DT±τ)179, i.e. (DT−τ)≦dt≦(DT+τ), where DT is as given in the existing status record for VCI, and τ is a defined segment delay variation tolerance parameter.

Failing 179, a supplementary test is applied in decision diamond 180. The test is whether dt falls in a window of double width and double delay, i.e whether dt is in the range:

2×(DT−τ)≦dt≦2×(DT+τ)

This would lend support to the assumption that the immediately previous packet had been discarded at an upstream segment multiplexing point. If both tests 179 and 180 fail, the real time status of the VCI is revoked. If either test 179 or 180 is affirmed, the status of the VCI remains confirmed and a check is carried out 182 as to whether the packet can be admitted on a relatively liberal (real time deferred discard) criterion L2. If B-Fill is less than L2, the packet is admitted, D is set 198 to zero, while R1, R2, T, and DT are set or reset, as appropriate for the confirmed real time status. If B-Fill equals or exceeds L2, the packet is marked 199 for discard and accordingly D=1, although the real time status is unaffected.

Continuing through the flow diagram in FIG. 9A past decision diamond 165, from 165 or on return via socket 11 from FIG. 9, at decision diamond 210 the logical status parameter D is checked. If D=1, the packet is discarded 211. If D=0, then the segment is written at 212 into location W in the VPI output buffer. At 213 a message is sent to the segment read controller 106 to inform the segment read controller 106 of the latest segment write address by signal ‘W-Sig(W)’. The new value of the output buffer fill (B-Fill) is calculated at 214: B-Fill=W−R, Modulo M, where M is the size of the buffer in segments and R is the next output buffer location from which a segment will read onto the output line. The address in the output buffer for the next segment write is calculated at 215. The process proceeds next to decision diamond 216 which is a repeat of decision diamond 163, testing whether the segment is a user segment (PT/=0XX). If it is not a user segment, the program would have bypassed all steps between 163 and 212, and now will bypass the further steps to the end, and go to 224 and return to the Await segment Arrival state. If it is a user segment, then just as following segment discard in 211, the program proceeds to decision diamond 217 to determine whether the segment was marked as End of Message by its Payload Type Identifier (PTI=0X1). If it was, then the VCI-Status is amended in 218, resetting N and D to zero and leaving remaining parameters unchanged; if it was not End of Message, then N is incremented by one at 219 making N equal to the number of segments of the presumed current packet that have by then actually arrived. The program goes to decision diamond 220 to check whether N equals D.Nₘₐₓ, which is related to the maximum number of segments permitted in a packet. If N equals it, then the VCI-Status is reset in total in 221, effectively terminating the packet and possible packet sequence and any elevated status; if it is not, the VCI-Status is updated in 222 with the new value for the N parameter. The Exit VCI-Status, whether produced in 218, 221, or 222 is written at 223 into VC Status Records, and the program is returned to 160, the Await segment Arrival state.

D.Nₘₐₓ, against which N is tested in 220 above, is a compounded binary integer made up of Nₘₐₓ, the maximum number of segments permitted in a packet by the Network, prefixed by D, which is the status parameter D, taken as a binary number. The packet termination at 220 is intended as a protective measure to prevent unlimited segment admission in cases of accidental, or willful, protocol failings where End-of-Message markings are omitted. The D prefix will not alter the maximum number of segments that could be admitted when D=0, but would more than double the possible number of segments that would be discarded when D=1 which is considered as being a step in the right direction to enhance the Network's performance.

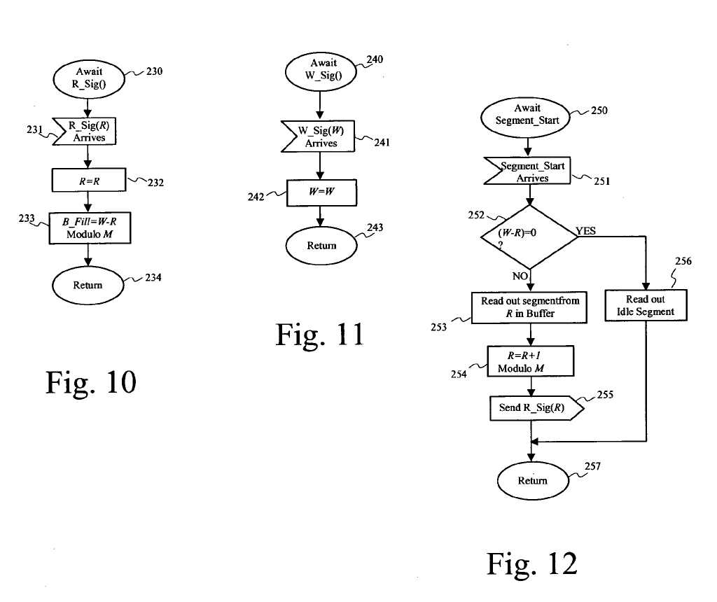

FIG. 10 is a process occurring in the packet admission & segment write controller 100 for reception in 231 of the signal from segment read controller 106 of the latest read address R. On reception of this value it is noted in 232, and the updated value for B-Fill is calculated in 233 and the program is returned to the Await Signal state.

FIG. 11 is a process occurring in the segment read controller 106 for the reception in 241 of the signal from the segment write controller 100 of the latest write address W. The address is noted in 242, and the program returned to the Await Signal state.

FIG. 12 is the principal program executed in the segment read controller 106. On arrival of a segment-start signal 251, a check is made in decision diamond 252 whether there are any segments for transmission in output buffer 104. If there are none (i.e. (W−R=0), an idle segment is read out at 256 from the idle segment generator 105. But if there are segments for read-out from the output buffer (i.e. (W−R≠0), the next in line segment is read out 253, and the pointer R for the next read-out is advanced by one in 254. The up-dated pointer value is sent to the packet admission & segment write controller 100 by signal 255. The program is returned at 257 to await segment start state 250.

The described embodiment of the invention contains variables and parameters, as listed in Table II. The performance and efficacy of any implementation will depend on values chosen for the design parameters in the circumstances of a given network (link bit rates, bit error rates, permitted packet sizes, segmentation etc.) Indications of reasonable parameter value choices can be obtained from simulation studies or more directly from system model analysis.

TABLE II
PARAMETERS AND VARIABLES

| Symbol | Type | Value/Range | Units | Description |
|---|---|---|---|---|
| N | Variable | 0→2¹¹-1 | segments | Sequence |
| | 10 bit | | | number |
| Nₘₐₓ | Parameter 16 | | segments | Maximum |
| | bits | | or | packet size |
| | | | octets | |
| D, R1, R2 | Logical | 1 or 0 | | Discard, |
| | variables 1 | | | RTprovisional, |
| | bit ea. | | | RTconfirmed |
| tₐ, T | Variables 28 | 0→2²⁷-1 | .5 ms | Arrival time |
| | bits ea. | | | |
| dt, DT | Variables 9 | 0→511 | .5 ms | Time between |
| | bits ea. | | | packets |
| τ | Parameter 3 | 0→7 | .5 ms | Variation |
| | bits | | | tolerance |
| Eₘᵢₙ, Eₘₐₓ | Parameters | 0→511 | .5 ms | Window Edges |
| | 10 bits ea. | | | |
| M | Parameter 14 | 2¹⁰→2¹⁴ | segments | output buffer |
| | or 6 bits | 2→63 | or | size |
| | | | packets | |
| B-fill | Variable | 0→M | segments | buffer fill |
| | | | or | |
| | | | packets | |
| Lc, Ls, L1, | Parameters | 0→M | segments | buffer fill |
| L2 | | | or | thresholds |
| | | | packets | |
| VCI | Identifier | | | Virtual |
| | 16 bits min. | | | channel |
| | | | | identifier |
| PTI | Identifier 3 | | | Payload type |
| | bits | | | identifier |
| LBR | Bandwidth | n × 155.52 | Mbps | Link bit rate |
| | | n = 1, 4, 8, . . . | | |

The above described particular embodiment of the invention relates to a specific technology, namely broadband Asynchronous Transfer Mode (ATM).

Different embodiments are possible without departing from the principles and claims of the invention. For instance, the described embodiment has two preference classes, designated as Classes 1 and 2. The higher preference class (Class 1) incorporates the loss shelter functionality to assist real time communications. A single class with real time assist functionality is possible, as also more than two classes are possible with or without real time assist.

Furthermore, in the above described embodiment link level frames are ATM segments conforming to ITU standards. Other link level frames conforming to different standards, or not conforming to any standards, are also possible, and indeed in the extreme, whole network level packets could be encapsulated in link level frames, obviating network packet segmentation. In all cases the invented procedures for safeguarding packet timeliness and for creating loss differentiation would still be applicable and provide advantage.

Finally, the described embodiment uses link level labels that identify virtual channels, paths payload type, etc. as given in ITU standards. Instead of these, other labels are possible, provided only that they satisfy the necessary functions and have the required uniqueness characteristics. Thus the labels need to have end of message or packet indication, payload type and quality class identification. For real time communication, a packet stream requires its own virtual connection and thus, irrespective of whether packets are segmented or not, real time streams could not be merged into a common path without individual stream identifiers.

Modifications and variations as would be apparent to a skilled addressee are deemed to be within the scope of the present invention.

1.-54. (canceled)

55. A method of managing transfer of packets in a digital communications network, at least some of said packets comprising a plurality of segments, said method comprising:
providing a buffer for storing segments arriving for transmission on a virtual channel;
always admitting a segment of a packet on a virtual channel for storage in the buffer when a previous segment of the packet on said virtual channel has been admitted in the buffer;
rejecting a segment of a packet on a virtual channel for storage in the buffer when a previous segment of the packet on said virtual channel has been rejected for storage; and
applying an admission criterion to each first segment of a packet on a virtual channel, said admission criterion being dependent on the level of fill of the buffer at the time of arrival of said first segment on the virtual channel and on a preference classification assigned to the virtual channel, and said admission criterion being used to determine whether to admit said first segment into the buffer.

56. A method as claimed in claim 55, wherein each preference classification has at least one associated buffer threshold fill level, said admission criterion for a packet on a virtual channel being dependent on a comparison of the actual buffer fill level at the time of arrival of the segment with the buffer threshold fill level associated with the preference classification assigned to the virtual channel.

57. A method as claimed in claim 56, wherein the buffer threshold fill levels are such that a relatively high preference classification has an associated relatively high buffer threshold fill level, and a relatively low preference classification has an associated relatively low buffer threshold fill level.

58. A method as claimed in claim 55, comprising assigning a preference classification to a virtual channel, each virtual channel having an associated virtual channel identifier, the step of assigning a preference classification comprising dividing virtual channel identifiers into at least two disjoint subsets, and assigning to each said subset a particular preference classification ranging from most preferred to least preferred.

59. A method as claimed in claim 55, wherein the network includes a plurality of network switches.

60. A method as claimed in claim 59, comprising communicating assigned preference classifications to all network switches in the network.

61. A method as claimed in claim 59, comprising storing at each network switch a status record for each virtual channel, said status record being indicative of whether a segment of a packet on a virtual channel arriving after a first segment in the packet should be discarded.

62. A method as claimed in claim 61, wherein the status record comprises data indicative of a serial number of the subsequent segment to arrive on a virtual channel, and a segment discard flag D indicative of whether the subsequent segment should be discarded.

63. A method as claimed in claim 61, wherein the status record comprises information associated with real time communications.

64. A method as claimed in claim 63, wherein said real time information comprises a real time provisional flag, a real time confirmed flag, a time stamp and a packet stream period.

65. A method as claimed in claim 61, comprising providing a random access memory for storing status records for all virtual channels on which segments may arrive for transmission.

66. A method as claimed in claim 61, comprising updating the status record associated with a segment at a network switch on arrival of the segment at the network switch.

67. A method as claimed in claim 66, comprising retrieving a status record associated with a segment on arrival of the segment at a network switch and using the discard flag in the status record to determine whether to store the segment in the buffer or discard the segment.

68. A method as claimed in claim 61, wherein a segment comprises a header having a payload type identifier (PTI) indicative of whether the segment is a user data segment, and the method comprises checking the PTI on arrival of a segment, storing the segment in the buffer if the segment is not a user data segment, and retrieving the status record associated with the segment if the segment is a user data segment.

69. A method as claimed in claim 68, comprising using the PTI in a received segment header to determine whether the segment corresponds to end of packet, amending the serial number in the status record associated with the segment to indicate that the next segment is the first segment in a subsequent packet, and amending the discard flag to indicate that the subsequent segment has not yet been marked for discard or storage in the buffer.

70. A method as claimed in claim 69, comprising incrementing the serial number in the status record if the PTI in a received segment header does not indicate end of packet.

71. A method as claimed in claim 55, wherein for communications networks having a maximum packet length, the method comprising checking whether the serial number is indicative of a packet exceeding the maximum packet length, and to reset the status record if a packet exceeding the maximum packet length is detected.

72. A method as claimed in claim 55, comprising detecting at a network switch arrival of a first segment in a packet, and when a first segment in a packet is detected:
determining the preference class of the virtual channel associated with the segment;
comparing the current buffer fill level with a threshold fill level associated with the preference class and
if the current buffer fill level is less than the associated threshold fill level, set the discard flag so as to indicate that the segment is not to be discarded; and
if the current buffer fill level is equal to or more than the associated threshold fill level, set the discard flag so as to indicate that the segment is to be discarded.

73. A method as claimed in claim 72, comprising:
if a virtual channel is determined to correspond to the highest preference class:
determining whether a virtual channel is associated with real time communication; and
if the virtual channel is associated with real time communication, assigning real time status to the virtual channel.

74. A method as claimed in claim 73, wherein the step of determining whether a virtual channel is associated with real time communication comprises monitoring an arrival pattern of packets on the virtual channel.

75. A method as claimed in claim 74, wherein the step of determining whether a virtual channel is associated with real time communication comprises monitoring the regularity of arrival of packets on the virtual channel.

76. A method as claimed in claim 75, wherein the step of determining whether a virtual channel is associated with real time communication comprises:
determining the time of arrival of a first segment in a packet;
comparing the current buffer fill level with a real time threshold buffer fill level;
if the current buffer fill level is less than the real time threshold buffer fill level, mark a provisional real time flag in the status record to indicate a possible real time communication;
if the provisional real time flag in the status record indicates a possible real time communication, calculate a time interval between arrival of a first segment in a current packet and arrival of a first segment in an immediately previous packet;
comparing the calculated time interval with minimum and maximum threshold time interval values;
if the calculated time interval is above the minimum time interval threshold and below the maximum time interval threshold, mark a confirmed real time flag in the status record to indicate a confirmed real time communication and thereby real time status for the virtual channel; and
storing the time interval as a reference time interval.

77. A method as claimed in claim 76, wherein the step of determining whether a virtual channel is associated with real time communication further comprises:
if the confirmed real time flag in the status record indicates a confirmed real time communication, calculating a time interval between arrival of a first segment in a current packet and arrival of a first segment in an immediately previous packet as each packet arrives on a virtual channel;
comparing the calculated time interval with the reference time interval;
if the calculated time interval is within a defined tolerance of the reference time interval, maintain the confirmed real time flag in the status record and thereby maintain real time status for the virtual channel; and
if the calculated time interval is not within the defined tolerance of the reference time interval, mark the provisional real time flag and the confirmed real time flag in the status record to indicate that the communication is not a real time communication, thereby revoking real time status for the virtual channel.

78. A method as claimed in claim 77, wherein the step of determining whether a virtual channel is associated with real time communication further comprises:
if the confirmed real time flag in the status record indicates a confirmed real time communication and thereby is assigned real time status, calculating a time interval between arrival of a first segment in a current packet and arrival of a first segment in an immediately previous packet as each packet arrives on a virtual channel;
comparing the calculated time interval with twice the reference time interval;
if the calculated time interval is within a defined tolerance of twice the reference time interval, maintaining the confirmed real time flag in the status record and thereby confirming real time status for the virtual channel; and
if the calculated constancy time interval is not within the defined tolerance of twice the reference time interval, mark the provisional real time flag and the confirmed real time flag in the status record to indicate that the communication is not a real time communication, thereby revoking real time status for the virtual channel.

79. A method as claimed in claim 55, wherein at least some of the packets comprise one segment.

80. A method as claimed in claim 55, wherein the communications network is an ATM network.

81. A method as claimed in claim 55, wherein the buffer is an output buffer of a network switch.

82. A network switch for managing transfer of packets in a digital communications network, at least some of said packets comprising a plurality of segments, said switch comprising:
a buffer for storing segments arriving for transmission on a virtual channel;
a packet and segment admission controller arranged to determine whether to admit a received segment into the buffer or to discard the segment;
the packet and segment admission controller being arranged to:
always admit a segment of a packet on a virtual channel for storage in the buffer when a previous segment of the packet on said virtual channel has been admitted in the buffer;
reject a segment of a packet on a virtual channel for storage in the buffer when a previous segment of the packet on said virtual channel has been rejected for storage; and
apply an admission criterion to each first segment of a packet on a virtual channel, said admission criterion being dependent on the level of fill of the buffer at the time of arrival of said first segment on the virtual channel and on a preference classification assigned to the virtual channel, and said admission criterion being used to determine whether to admit said first segment into the buffer.

83. A network switch as claimed in claim 82, wherein each preference classification has at least one associated buffer threshold fill level, said admission criterion for a packet on a virtual channel being dependent on a comparison of the actual buffer fill level at the time of arrival of the segment with the buffer threshold fill level associated with the preference classification assigned to the virtual channel.

84. A network switch as claimed in claim 83, wherein the buffer threshold fill levels are such that a relatively high preference classification has an associated relatively high buffer threshold fill level, and a relatively low preference classification has an associated relatively low buffer threshold fill level.

85. A network switch as claimed in claim 82, wherein each virtual channel having an associated virtual channel identifier, and the virtual channel identifiers are divided into at least two disjoint subsets, each said subset being assigned a particular preference classification ranging from most preferred to least preferred.

86. A network switch as claimed in claim 82, comprising a storage device arranged to store a status record for each virtual channel, said status record being indicative of whether a segment of a packet on a virtual channel arriving after a first segment in the packet should be discarded.

87. A network switch as claimed in claim 86, wherein the status record comprises data indicative of a serial number of the subsequent segment to arrive on a virtual channel, and a segment discard flag D indicative of whether the subsequent segment should be discarded.

88. A network switch as claimed in claim 86, wherein the status record comprises information associated with real time communications.

89. A network switch as claimed in claim 88, wherein said real time information comprises a real time provisional flag, a real time confirmed flag, a time stamp and a packet stream period.

90. A network switch as claimed in claim 86, wherein the storage device comprises a random access memory.

91. A network switch as claimed in claim 82, wherein the network switch is arranged to update the status record associated with a segment at a network switch on arrival of the segment at the network switch.

92. A network switch as claimed in claim 91, wherein the network switch is arranged to retrieve a status record associated with a segment on arrival of the segment at a network switch and to use the discard flag in the status record to determine whether to store the segment in the buffer or discard the segment.

93. A network switch as claimed in claim 82, wherein a segment comprises a header having a payload type identifier (PTI) indicative of whether the segment is a user data segment, and the network switch is arranged to check the PTI on arrival of a segment, to store the segment in the buffer if the segment is not a user data segment, and to retrieve the status record associated with the segment if the segment is a user data segment.

94. A network switch as claimed in claim 93, wherein the network switch is arranged to use the PTI in a received segment header to determine whether the segment corresponds to end of packet, to amend the serial number in the status record associated with the segment to indicate that the next segment is the first segment in a subsequent packet, and to amend the discard flag to indicate that the subsequent segment has not yet been marked for discard or storage in the buffer.

95. A network switch as claimed in claim 92, wherein the network switch is arranged to increment the serial number in the status record if the PTI in a received segment header does not indicate end of packet.

96. A network switch as claimed in claim 82, wherein for communications networks having a maximum packet length, the network switch is arranged to check whether the serial number is indicative of a packet exceeding the maximum packet length, and to reset the status record if a packet exceeding the maximum packet length is detected.

97. A network switch as claimed in claim 82, wherein the network switch is arranged to detect at a network switch arrival of a first segment in a packet, and when a first segment in a packet is detected to:
determine the preference class of the virtual channel associated with the segment;
compare the current buffer fill level with a threshold fill level associated with the preference class and
if the current buffer fill level is less than the associated threshold fill level, set the discard flag so as to indicate that the segment is not to be discarded; and
if the current buffer fill level is equal to or more than the associated threshold fill level, set the discard flag so as to indicate that the segment is to be discarded.

98. A network switch as claimed in claim 97, wherein if a virtual channel is determined to correspond to the highest preference class, the network switch is arranged to:
determine whether a virtual channel is associated with real time communication;
if the virtual channel is associated with real time communication, assigning real time status to the virtual channel.

99. A network switch as claimed in claim 98, wherein the network switch is arranged to determine whether a virtual channel is associated with real time communication by monitoring an arrival pattern of packets on the virtual channel.

100. A network switch as claimed in claim 99, wherein the network switch is arranged to determine whether a virtual channel is associated with real time communication by monitoring the regularity of arrival of packets on the virtual channel.

101. A network switch as claimed in claim 100, wherein the network switch is arranged to determine whether a virtual channel is associated with real time communication by:
determining the time of arrival of a first segment in a packet;
comparing the current buffer level with a real time threshold buffer fill level;
if the current buffer fill level is less than the real time threshold buffer fill level, mark a provisional real time flag in the status record to indicate a possible real time communication;
if the provisional real time flag in the status record indicates a possible real time communication, calculate a time interval between arrival of the first segment in the packet and arrival of a first segment in an immediately previous packet;
comparing the calculated time interval with minimum and maximum threshold time interval values; and
if the calculated time interval is above the minimum time interval threshold and below the maximum time interval threshold, mark a confirmed real time flag in the status record to indicate a confirmed real time communication, store the calculated time interval as a reference time interval.

102. A network switch as claimed in claim 101, wherein the network switch is further arranged to determine whether a virtual channel is associated with real time communication by:
if the confirmed real time flag in the status record indicates a confirmed real time communication and thereby real time status for the virtual channel, calculating a time interval between arrival of a first segment in a current packet and arrival of a first segment in an immediately previous packet as each packet arrives on a virtual channel;
comparing the calculated time interval with the reference time interval;
if the calculated time interval is within a defined tolerance of the reference time interval, maintain the confirmed real time flag in the status record and thereby maintain real time status for the virtual channel; and
if the calculated time interval is not within the defined tolerance of the reference time interval, mark the provisional real time flag and the confirmed real time flag in the status record to indicate that the communication is not a real time communication, thereby revoking real time status for the virtual channel.

103. A network switch as claimed in claim 102, wherein the network switch is further arranged to determine whether a virtual channel is associated with real time communication by:
if the confirmed real time flag in the status record indicates a confirmed real time communication and thereby real time status for the virtual channel, calculating a time interval between arrival of a first segment in a current packet and arrival of a first segment in an immediately previous packet as each packet arrives on a virtual channel;
comparing the calculated time interval with twice the reference time interval;
if the calculated constancy time interval is within a defined tolerance of twice the reference time interval, maintain the confirmed real time flag in the status record and thereby maintain real time status for the virtual channel; and
if the calculated constancy time interval is not within the defined tolerance of twice the reference time interval, mark the provisional real time flag and the confirmed real time flag in the status record to indicate that the communication is not a real time communication, thereby revoking real time status for the virtual channel.

104. A network switch as claimed in claim 82, wherein the buffer is an output buffer.

105. A communications network comprising a plurality of network switches as claimed in claim 82, said switches being interconnected in a mesh network.

106. A communications network as claimed in claim 105, wherein assigned preference classifications are communicated to all network switches in the network.

107. A communications network as claimed in claim 105, wherein the communications network is an ATM network.

108. A semiconductor chip comprising a network switch as claimed in claim 82.
